(19) United States
(12) Patent Application Publication
(10) Pub. No.: US 2009/0195156 A1
(43) Pub. Date: Aug. 6, 2009

(54) FLASH UNIT

(75) Inventor: Jun-Han Lin, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/052,078

(22) Filed: Mar. 20, 2008

(30) Foreign Application Priority Data
Jan. 31, 2008 (CN) 200810300283.6

(51) Int. Cl. H01J 61/00

(52) U.S. Cl. 313/567

(57) ABSTRACT

A flash unit for an image capturing device includes a noble gas-filled flash tube and two electrical terminals. The outer surface of the flash tube includes a light-transmissive portion and a light-reflective portion. The two electrical terminals protrude outwards from the two opposite ends of the flash tube respectively for allowing application of a high voltage pulse to the noble gas for creating a flash of light.

### TECHNICAL FIELD

The present invention relates to a flash unit, and, particularly, to a flash unit for an image capturing device.

### DESCRIPTION OF RELATED ART

Image capturing devices, such as film cameras, digital cameras, or mobile phones equipped with a camera module, typically employ a flash unit to illuminate a subject in low light.

Referring to FIG. 3, a flash unit 100 includes a flash tube 110, a reflector 120, a rubber 130, and a shield 140. The flash tube 110 is disposed within the reflector 120. The rubber 130 is configured for maintaining the flash tube 110 and the reflector 120 together. The shield 140 is used to seal an opening of the reflector 120 for protecting the flash tube 110.

The flash tube 110 includes a cylindrical tube 101 and two electrical terminals 102, respectively protruding outwards from opposite ends of the cylindrical tube 101, to which voltage is applied.

The flash unit 110 has many components such as the reflector 120, the rubber 130, the flash tube 110, and the shield 140, and therefore is bulky and inconvenient to assemble (this also increases its cost).

Therefore, it is desirable to provide a flash unit, which can overcome the above-mentioned problems.

### SUMMARY

A flash unit for an image capturing device is disclosed. The flash unit includes a noble gas-filled flash tube and two electrical terminals. The outer surface of the flash tube includes a light-transmissive portion and a light-reflective portion. The two electrical terminals protrude outward from opposite ends of the flash tube respectively for application of a high voltage pulse thereto cause flashing of the noble gas.

### BRIEF DESCRIPTION OF THE DRAWING

Many aspects of the present assembly of the flash unit can be better understood with reference to the following drawings. The components in the drawing are not necessarily drawn to scale, the emphasis instead being placed upon clearly illustrating the principles of the present assembly of the flash unit.

FIG. 1 is an isometric, schematic view of a flash unit including a flash tube according to an exemplary embodiment;

FIG. 2 is a cross-sectional view of the transparent tube of FIG. 1; and

FIG. 3 is an isometric, exploded view of a flash unit including a flash tube in accordance with a related art.

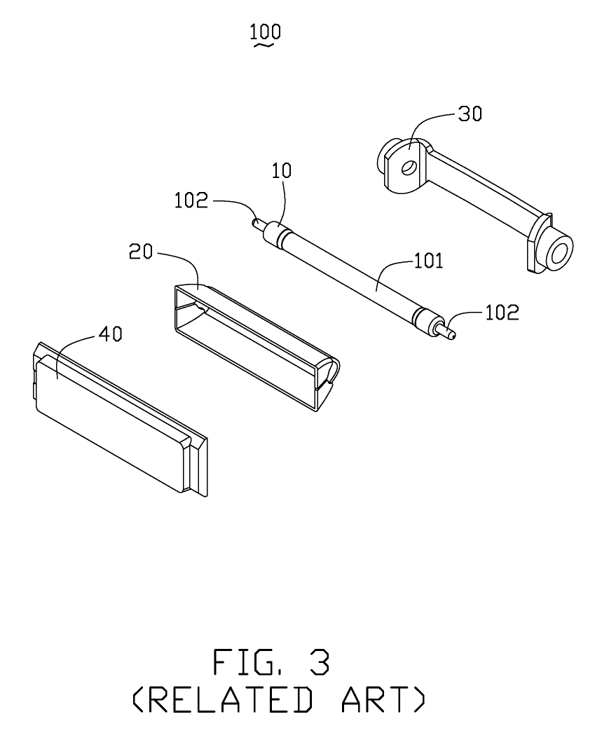

### DETAILED DESCRIPTION OF THE EMBODIMENTS

Embodiments of the present invention will now be described in detail below, with reference to the drawings.

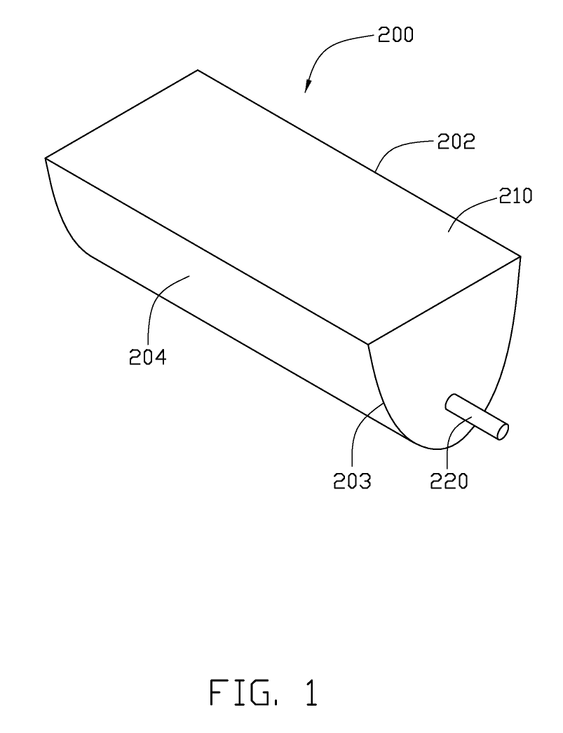

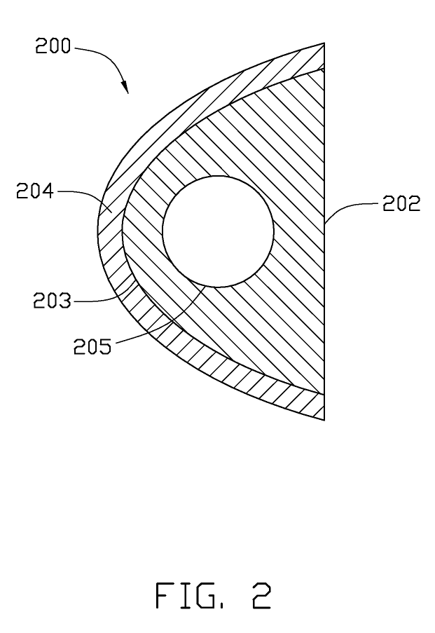

Referring to FIGS. 1-2, a flash unit 200 includes a flash tube 210 with two electrical terminals 220 respectively protruding out from opposite ends of the flash tube 210. The two electrical terminals 220 are connected to an external power source (not shown) for application of a high voltage pulse thereto.

The flash tube 210 is made of transparent material such as transparent glass or transparent plastic.

The flash tube 210 is filled with a noble gas 205, such as xenon gas, which is configured to create a bright flash when energized by the high voltage pulse. The outer surface of the flash tube 210 includes a planar portion 202 and a parabolic portion 203 connected with the planar portion 202. The planar portion 202 is configured for transmitting the flash of light created by the noble gas 205 out from the flash tube 210. The parabolic portion 203 is formed (e.g., coated) with a light-reflective film 204, and therefore is capable of collecting and reflecting the flash of light in a focused manner.

Understandably, the curvature of the parabolic portion 203 can be changed in different models to control the direction/distribution of light from the flash unit 200. It also should be understood that the planar portion 202 can be replaced by the parabolic portion 203, thereby efficiently controlling the degree of concentration of the flash of light.

The flash unit 200 is integrally formed (no assembly work is needed), and therefore is more amenable to miniaturization, and decreasing manufacturing costs.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A flash unit for an image capturing device, comprising:
a flash tube having an outer surface that comprises a parabolic portion;
a light-reflective film disposed on the parabolic portion; and
two electrical terminals protruding outwards from the ends of the flash tube respectively.

2. The flash unit as claimed in claim 1, wherein the flash tube is filled with a noble gas configured for creating a flash of light when a high voltage pulse is applied to the two electrical terminals.

3. The flash unit as claimed in claim 1, wherein the noble gas is xenon gas.

4. The flash unit as claimed in claim 1, wherein the outer surface of the flash tube further comprises a planar portion configured for emitting the flash of light outward.

5. The flash unit as claimed in claim 1, wherein the flash tube is made of transparent material.

6. The flash unit as claimed in claim 1, wherein the transparent material is transparent glass or transparent plastic.

7. A flash unit for an image capturing device, comprising:
a noble gas-filled flash tube having an outer surface that comprises a light-transmissive portion and a light-reflective portion; and
two electrical terminals protruding outwards from the ends of the flash tube respectively for application of a high voltage pulse thereto for energizing the noble gas for creating a flash of light which is emitted out of the flash tube from the light-transmissive portion thereof.

8. The flash unit as claimed in claim 7, wherein the light-transmissive portion is connected with the light-reflective portion.

9. The flash unit as claimed in claim 7, wherein the flash tube is transparent.

10. The flash unit as claimed in claim 7, wherein the noble gas is xenon.

11. The flash unit as claimed in claim 7, wherein the light-reflective portion is coated with a reflective film.

12. The flash unit as claimed in claim 7, wherein the light-reflective portion is a curved surface.

13. The flash unit as claimed in claim 7, wherein the light-transmissive portion is a planar surface.
